(19) United States
(12) Patent Application Publication
(10) Pub. No.: US 2024/0338563 A1
(43) Pub. Date: Oct. 10, 2024

(54) METHODS AND APPARATUS FOR DATA-EFFICIENT CONTINUAL ADAPTATION TO POST-DEPLOYMENT NOVELTIES FOR AUTONOMOUS SYSTEMS

(71) Applicant: Intel Corporation, Santa Clara, CA (US)

(72) Inventors: Amanda Sofie Rios, Los Angeles, CA (US); Nilesh Ahuja, Cupertino, CA (US); Ibrahima Jacques Ndiour, Chandler, AZ (US); Ergin Utku Genc, Portland, OR (US); Omesh Tickoo, Portland, OR (US)

(21) Appl. No.: 18/744,278

(22) Filed: Jun. 14, 2024

(51) Int. Cl. G06N 3/08

(52) U.S. Cl. CPC G06N 3/08

(57) ABSTRACT

An example apparatus includes interface circuitry, machine-readable instructions, and at least one processor circuit to be programmed by the machine-readable instructions to extract neural network model features from deployment data, identify out-of-distribution data based on the neural network model features, identify samples with the out-of-distribution data to generate one or more scores associated with post-deployment data drift, and classify post-deployment data based on the one or more scores.

### BACKGROUND

Novelty detection, also known as outlier or out-of-distribution (OOD) detection, involves improving the ability of a machine learning model to recognize and handle data that deviates significantly from the model's training set. Out-of-distribution data can cause significant reductions in the performance of a neural network. Detection and effective handling of OOD data is important for adaptability in AI-based performance.

### BRIEF DESCRIPTION OF THE DRAWINGS

FIG. 1 illustrates example continual monitoring of post-deployment data drifts associated with out-of-distribution data, in accordance with teachings of this disclosure.

FIG. 2 is a block diagram of an example implementation of data drift detector circuitry constructed in accordance with teachings of this disclosure to continuously detect out-of-distribution data and integrate the out-of-distribution data for use in a deployable artificial intelligence (AI) system.

FIG. 3 is a flowchart representative of example machine-readable instructions and/or example operations that may be executed, instantiated, and/or performed by example programmable circuitry to implement the example data drift detector circuitry of FIG. 2.

FIG. 4 is a flowchart representative of example machine-readable instructions and/or example operations that may be executed, instantiated, and/or performed by example programmable circuitry to implement the example data drift detector circuitry of FIG. 2 to perform deep feature extraction and initial uncertainty score identification.

FIG. 5 is a flowchart representative of example machine-readable instructions and/or example operations that may be executed, instantiated, and/or performed by example programmable circuitry to implement the example data drift detector circuitry of FIG. 2 to initiate iterative recruitment with tunable active supervision.

FIG. 6A illustrates example iterative recruitment for incremental estimation of novelty, including an in-distribution validation threshold.

FIG. 6B illustrates example iterative recruitment with newer and older distributions separating in later tasks as identification of out-of-distribution data improves over time based on successive re-estimation of novelty scores.

FIG. 7A illustrates an example first set of iterative recruitment results showing an in-distribution validation set threshold.

FIG. 7B illustrates an example second set of iterative recruitment results showing data distributions separated through iterations of successive re-estimation of novelty scores.

FIG. 8 illustrates an example of incremental classification accuracy over given number of tasks based on input of unlabeled data including in-distribution and out-of-distribution samples.

FIG. 9A illustrates example results including average precision and recall associated with continual novelty detection performance with multiple shifts in deployment distribution.

FIG. 9B illustrates an increase in novelty detection capacity over time when using active learning in combination with data including pseudo-labeling as compared to the use of data with pseudo-labeling alone.

FIG. 9C illustrates increased efficiency when using active learning as compared to using simple semi-supervised learning.

FIG. 10 is a block diagram of an example processing platform including programmable circuitry structured to execute, instantiate, and/or perform the example machine readable instructions and/or perform the example operations of FIGS. 3-5 to implement the data drift detector circuitry of FIG. 2.

FIG. 11 is a block diagram of an example implementation of the processor circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Deep neural networks are frequently trained under a closed-world assumption, presuming that a test data distribution closely mirrors the training data distribution. Out-of-distribution (OOD) data can significantly reduce the network's performance in terms of accuracy. For instance, an AI system encountering OOD data in a home robotics setting can misinterpret an object or a command. Likewise, an AI system encountering OOD data in a medical setting can result in patient misdiagnosis. As such, the detection and handling of OOD data is important for effective AI system performance. In particular, data distribution can change over time in real-world applications (e.g., resulting in a dataset drift). Autonomous system models based on deep neural networks (e.g., autonomous vehicles) are known to exhibit brittleness to dataset drift occurring post-deployment, given that observed distributions deviate from the model's original training data. Dataset drifts may be affected by environmental changes (e.g., illumination conditions, noise, weather, etc.). In these dataset drift scenarios, autonomous system models can (1) fail to diagnose a data drift when the drift occurs and/or (2) continue generating erroneous yet overconfident predictions, leading to model performance degradation.

Existing solutions to improving model performance in the presence of dataset drift include the application of continual learning to fully supervised datasets and/or the application of static novelty/out-of-distribution detection methods. For example, use of continual learning can prevent catastrophic forgetting (a tendency of an artificial neural network to abruptly and/or drastically forget previously learned information). Continual learning-based models rely on fully supervised data and require the presence of a novelty oracle indicating when the model needs to adapt, as well as indications of the labels of the novel data. Overall, continual learning solutions have adopted an array of different algorithms to address forgetting (including regularization techniques, replay of past data, network partitioning, and weight masking). Methods focusing on the use of outlier or OOD detection for improving neural network model performance focus on training the network to generate an uncertainty score (an uncertainty score associated with the output) for each input received by the network. The uncertainty score can be generated using a softmax score, as well as temperature-scaled variants of the softmax score (e.g., generalized ODIN, Bayesian networks and ensembles, etc.), deep reconstruction, and/or likelihood-based approaches.

Known solutions to impaired neural network model performance in the presence of dataset drift require a novelty oracle to inform the model about incoming novelties, which is unrealistic for post-deployment adaptation scenarios. Past continual learning solutions have largely focused on the forgetting component of continual adaptation but have taken for granted continual novelty detection. As such, few continual learning approaches have focused on unsupervised or semi-supervised continually adaptive learning, which can be viewed as the intersection of out-of-distribution and continual learning-based approaches. Solutions for novelty-detection/OOD have been developed exclusively for static, offline use and scale poorly to continual novelty detection. Known solutions use existing static OOD approaches and are not able to produce reliable and/or scalable performance in the continual novelty detection setting. Lack of scalability and reliability arises from sensitivity to continual error propagation when the model accumulates improperly estimated knowledge. Additionally, known solutions involve computationally expensive re-training (e.g., deep neural network backpropagations) and poor scalability to environments with growing data imbalance and/or multi-class novelties.

Example methods and apparatus disclosed herein introduce high-performing, updatable data drift detection, allowing autonomous systems to continually detect post deployment data drifts and trigger updates in response to detected novel data. In examples disclosed herein, continuous novelty detection of novel classes (e.g., data drift detection) can be performed under fully unsupervised or semi-supervised conditions, including using a small tunable active learning budget to enhance continual detection performance in more challenging operational scenarios. In examples disclosed herein, an iterative novelty-recruitment algorithm can operate on frozen post-deployment deep neural network features, bypassing computationally expensive re-trainings of deep neural networks (DNNs) and achieving low latency adaptation suitable to edge applications. In examples disclosed herein, novel samples are continuously identified in real-time and subsequently incorporated into the training data for all future neural network model updates. Once detected, novel samples cease to be flagged as novelties in subsequent evaluations. In examples disclosed herein, continual adaptive novelty detection includes identifying an uncertainty score based on a feature reconstruction error.

Example methods and apparatus disclosed herein further prevent the propagation of continual errors by performing multiple iterations for each novel task instead of a single comprehensive analysis. For example, during each iteration, methods and apparatus disclosed herein select the most certain novel samples for each estimated novel class, pseudo-labeling the novel samples as part of the novel class. Additionally, methods and apparatus disclosed herein identify the most uncertain and ambiguous novel samples, which can be actively labeled by a domain expert. In examples disclosed herein, continuous novelty detection is versatile, functioning effectively in both supervised and unsupervised scenarios, allowing seamless adaptation to various deployment contexts.

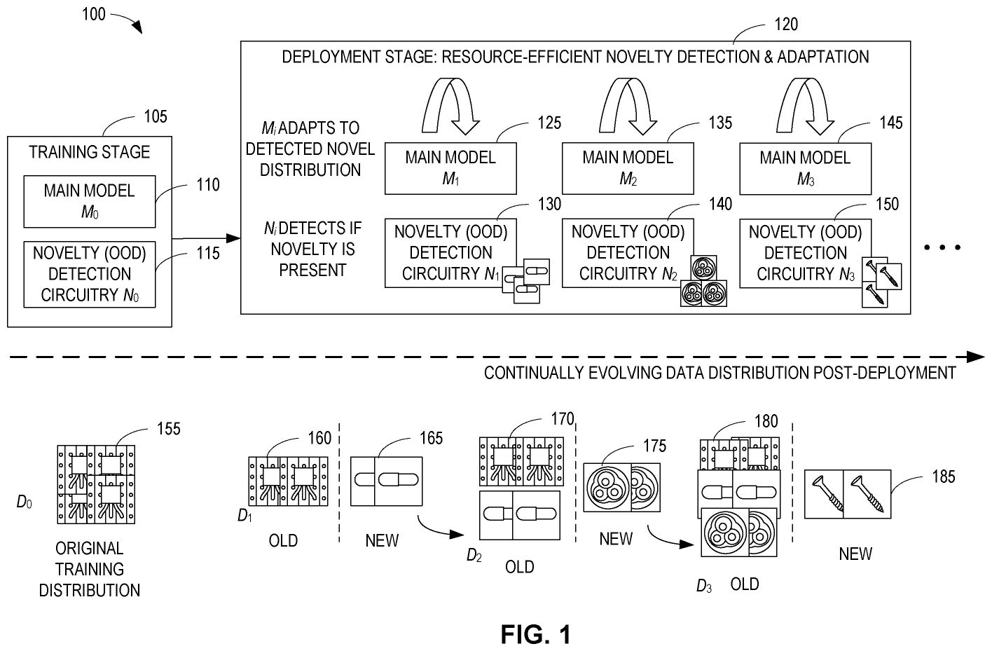

FIG. 1 illustrates example continual monitoring 100 of post-deployment data drifts associated with out-of-distribution data. Most artificial intelligence (AI)-based systems are developed and deployed with static datasets, under the assumption that the training distribution mirrors the deployment distribution and that both remain static for the duration of deployment. However, AI-based systems are often faced with vast amounts of non-static, continuously evolving data. For instance, AI models deployed in self-driving cars encounter terrains, objects, and/or weather conditions (e.g., data distribution changes) that are not encountered during the training phase, requiring the models to adapt to these new conditions continuously. Practical deployment of continual learning AI systems in real-world scenarios includes detecting data distribution changes continuously through time (e.g., using continual novelty detection). Continual novelty detection focuses on identification of out-of-distribution (OOD) data. Methods and apparatus disclosed herein provide continual OOD/novelty detection with active learning solutions focused on a continual post-deployment data drift regime, combining both OOD and active learning capabilities.

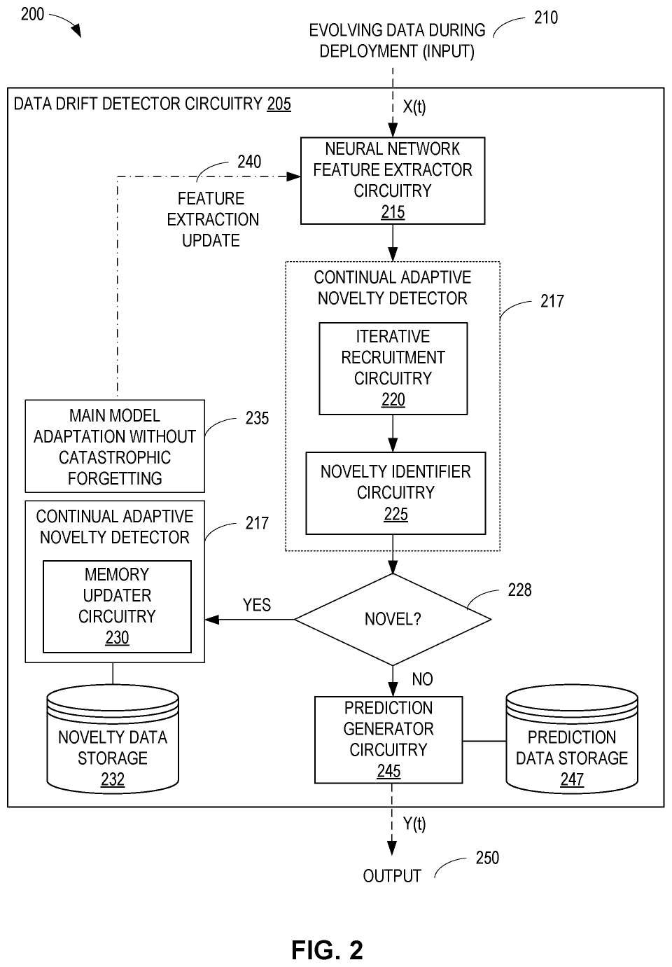

In the example of FIG. 1, continuous novelty detection can be performed using a continual adaptive novelty detector, which introduces an iterative recruitment algorithm to estimate if and/or when novelties are present during deployment, as described in more detail in connection with FIG. 2. If the novelty detector identifies novelties present during deployment, the detector updates the detection process using the acquired novelties. In examples disclosed herein, the novelty detector can operate in both unsupervised environments and/or with the aid of an active learning solution designed specifically for continual novelty detection and integration. In the example of FIG. 1, novel samples are continuously identified in real-time and are subsequently incorporated into the training data for all future model updates.

For example, the continual monitoring 100 of FIG. 1 includes an example training stage 105 and an example deployment stage 120 associated with resource-efficient novelty detection and adaptation. In the example of FIG. 1, the training stage 105 includes a main model (M₀) 110 and a novelty (OOD) detection circuitry (No) 115. The novelty detection circuitry 115 is continuously updated (e.g., novelty detection circuitry (No) 115 is updated to novelty detection circuitry N1 130, N2 140, N3 150, etc.) during novelty detection performed in tandem with the main model, which is also continuously updated based on the identified novelties (e.g., data shifts) that arise during deployment (e.g., main model (M₀) 110 updates to main model(s) M₁ 125, M₂ 135, M₃ 145). As such, the novelty detection circuitry 115 updates itself continually (e.g., by changing data and/or instructions) such that distributions initially identified by the novelty detection circuitry 115 as novel (e.g., using a pool of unlabeled data) are no longer flagged as novel. Likewise, the main model continuously adapts to the detected novel distribution identified by the novelty detection circuitry 115. In the example of FIG. 1, an original training distribution (Do) includes a first image 155, while subsequent training distributions include additional new image(s) 165, 175, 185. For example, the original training distribution (D₀) represents the training distribution used for training the main model (M₀) 110. An example first training distribution (D₁) 160 includes the first image 155 and a second image 165. The data distribution is continually updated such that an example second training distribution (D₂) 170 incorporates the first and second image(s) 155, 165, as well as a third image 175. Subsequently, an example third training distribution (D₃) 180 includes the first, second, and third image(s) 155, 165, 175 and a fourth image 185. Once detected, the novel samples (e.g., image(s) 165, 175, 185) cease to be flagged as novelties in subsequent evaluations. As such, this continuous novelty detection mechanism is integrated with the deployed main model (e.g., via classification circuitry). Upon identification of novel samples using novelty detection, the samples are either pseudo-labeled (e.g., using clustering) or actively labeled (e.g., using methods derived from active learning). Subsequently, the main model is adapted through the assimilation of these newly acquired samples, as described in more detail in connection with FIG. 2, enhancing the main model's performance and adaptability.

In examples disclosed herein, continual adaptive novelty detection is performed (e.g., using data drift detector circuitry 205 of FIG. 2) to construct a novelty estimate by analyzing intermediate features generated by the deployed main model (M₀) 110 of FIG. 1 (e.g., via classification circuitry). For example, continual adaptive novelty detection results in the evaluation of the intermediate features using a statistical model and computation of an uncertainty score based on a feature reconstruction error, as described in more detail in connection with FIG. 2. To prevent the propagation of continual errors, the data drift detector circuitry 205 incrementally refines this statistical model, performing multiple iterations for each novel task instead of a single comprehensive analysis. During each iteration, the data drift detector circuitry 205 selects novel samples having a high level of certainty for each estimated novel class and pseudo-labels the novel samples as part of that class. Additionally, the data drift detector circuitry 205 identifies novel samples having high levels of ambiguity and uncertainty, such that these identified samples can be actively labeled by a domain expert (e.g., with 5% to 15% of all samples flagged as novel, etc.).

FIG. 2 is a block diagram 200 illustrating an example implementation of data drift detector circuitry 205 to continuously detect out-of-distribution data and integrate the out-of-distribution data for use in a deployable artificial intelligence (AI) system. The data drift detector circuitry 205 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the data drift detector circuitry 205 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the example of FIG. 2, the data drift detector circuitry 205 includes an example neural network feature extractor circuitry 215, an example iterative recruitment circuitry 220, an example novelty identifier circuitry 225, an example memory updater circuitry 230, an example novelty data storage 232, an example prediction generator circuitry 245, and an example prediction data storage 247.

The neural network feature extractor circuitry 215 performs feature extraction from a deep neural network (DNN) main model (e.g., main model (M₀) 110 of FIG. 1). For example, the neural network feature extractor circuitry 215 extracts intermediate features from given layer(s) of a deployed DNN that has been trained on original in-distribution (ID) pre-deployment data and/or pre-trained on any other type of large dataset (e.g., ImageNet, etc.). For example, the neural network feature extractor circuitry 215 extracts detailed features (e.g., edges, corners, curves, etc.), followed by more general features corresponding to dominant object(s) in the image (e.g., faces, figures, whole objects, etc.). In the example of FIG. 2, the neural network feature extractor circuitry 215 receives evolving data during deployment of the AI-based main model (e.g., input 210). In some examples, the neural network feature extractor circuitry 215 receives a feature extraction update 240 if there are updates to the main model as part of the continual adaptive novelty detection described in more detail below.

The iterative recruitment circuitry 220 performs iterative recruitment to estimate when novel data (e.g., out-of-distribution data) is present during model deployment (e.g., as part of a continual adaptive novelty detector 217). For example, the iterative recruitment circuitry 220 applies a static out-of-distribution (OOD) assessment to deep features (e.g., extracted using the neural network feature extractor circuitry 215) to generate initial uncertainty scores. In some examples, the iterative recruitment circuitry 220 uses static OOD assessment to identify high dimensional deep features of each in-distribution class and learns a low dimensional manifold (e.g., using per-class principal component analysis (PCA)). In some examples, the iterative recruitment circuitry 220 uses computed per-class PCA transforms to generate per-class feature reconstruction errors (FREs) which measure an uncertainty associated with belonging to a class (e.g., given as an L2 norm, also known as a Euclidean norm, between an original input and a pre-image of the input, as generated by an inverse PCA of that class). For example, a sample that does not belong to a particular class distribution will usually result in a large reconstruction score using the PCA transform associated with a given class, indicating OOD with respect to the identified class.

Prior to deployment of the main mode, the original in-distribution classes are referred to as being in-distribution and their respective PCA transforms are stored in memory. During deployment, the iterative recruitment circuitry 220 gauges a pool of new unlabeled samples (e.g., at each task) for possible novelties by computing the feature reconstruction error (FRE) per each of the classes stored in memory to identify an initial novelty score (e.g., score S_(old, t=task)). In some examples, the iterative recruitment circuitry 220 initiates iterative recruitment to iteratively estimate a detected novel distribution further (e.g., when a significant number of the samples are above an error threshold). In some examples, the iterative recruitment circuitry 220 stores the finalized estimates of novel per-class parameters (PCAs) (e.g., using the novelty data storage 232 and/or the prediction data storage 247). Any other per-class uncertainty scores beyond FRE can be accommodated, since the iterative recruitment disclosed herein is agnostic to a precise per-class uncertainty metric (e.g., when using principal component analysis parameters (e.g., PCAs) stored in memory). As described in examples disclosed herein, uncertainty scores that measure distance to in-distribution (ID) classes are used as initial novelty scores, such that iterative recruitment is performed to determine whether the scores are novel and identify which samples are novel, with updated novelty scores identified at each iteration using the novelty identifier circuitry 225.

The novelty identifier circuitry 225 identifies novelty scores at each iteration based on the iterative recruitment circuitry 220. In examples disclosed herein, iterative recruitment novelty scores (S_{t,i}) are initialized as S_{t,i=0}=S_{old,t}, such that a linear separation between out-of-distribution and in-distribution samples should not be relied on using only S_{old,t=task} scores, instead re-estimating novelty scores at each iteration via iterative recruitment. For example, during the first iteration, the novelty identifier circuitry 225 selects R/N samples (e.g., R selected samples out of a total number of samples N) with the highest novelty scores (S_{t,i}) to be pseudo-labelled as novel and estimates a new PCA transform per novel class. In some examples, the novelty identifier circuitry 225 initializes k PCA transforms using an elbow method (e.g., graphical method for finding the optimal K value in a k-means clustering algorithm). For example, the novelty identifier circuitry 225 determines k using an algorithm for choosing initial values (e.g., k-means++ algorithm, etc.) followed by the elbow method and assignment of R selected samples to the closest k means. In some examples, the novelty identifier circuitry 225 uses each of the k subsets to compute a novel PCA transform (e.g., PCA transform defined as T_{j,t,i=0}j∈k).

Alternatively, if the novelty identifier circuitry 225 identifies that active labeling (e.g., selection of training data for labeling) is available, then the novelty identifier circuitry 225 uses ground-truth labels of samples obtained at the first iteration to indicate how many k novel classes are present and can be used to initialize the novel k classes. At subsequent iterations, the novelty identifier circuitry 225 selects the next topmost R/N samples (e.g., with highest novelty scores per novel class) to pseudo-label as one of the novel k classes (e.g., based on the closest novel PCAs). Additionally, if active labeling is available, the novelty identifier circuitry 225 selects samples with ambiguous (e.g., uncertain) novelty scores to actively label (e.g., by querying a domain expert for ground truth class label(s) of the sample). In examples disclosed herein, pseudo labeling corresponds to labeling of samples with topmost high novelty scores, removing the samples from the unlabeled pool, and adding the pseudo labelled sample to a selected set of samples. In examples disclosed herein, active labeling corresponds to actively querying a small set of samples with ambiguous novelty scores (e.g., when a labeling budget is available) for the ground truth label of the samples and removing these identified samples from the unlabeled pool of samples (e.g., if a sample's ground truth is identified as being new, such samples are also incorporated into the selected set). In examples disclosed herein, the selected samples identified using pseudo labeling and active labeling, as well as using past iterations, are used to re-estimate novelty scores for subsequent iterations.

In examples disclosed herein, ambiguousness and/or uncertainty is defined as a distance to an in-distribution/out-of-distribution (ID/OOD) decision boundary estimated as the upper-bound of a small validation set containing only in-distribution hold out samples. In examples disclosed herein, the novelty identifier circuitry 225 re-computes novel k PCA transforms using all selected samples (e.g., samples that are pseudo-labeled or actively labeled using one of k novel labels) along with previous iteration-based selections. The novelty identifier circuitry 225 subsequently re-computes the novelty scores (S_{t,i}) using the most recent PCA transform estimates, in accordance with Equation 1 (e.g., where FRE corresponds to a feature reconstruction error and PCA corresponds to a per-class principal component analysis):

$$\\ \begin{matrix}{S}_{t , i , k} = γ \frac{{min}_{m ∈ Memory} FRE ( {u}_{t} , {T}_{m} )}{FRE ( {u}_{t} , {T}_{k , i - 1} )} ⇔ FRE ( x , PCA ) = {\vert x - ( {PCA}^{{}_{} t} ∘ PCA ) \vert}_{2} & Equation 1\end{matrix}$$

$$\\ where {S}_{t , i} = {max}_{k ∈ New} {S}_{t , i , k}$$

The memory updater circuitry 230 stores and/or consolidates the final k new PCAs (e.g., [symbol] {T [symbol] _{k∈New,i=final}}) after iterative recruitment is completed. For example, the stored PCAs can be used to gauge closeness to past tasks. In examples disclosed herein, storage of the PCAs in memory does not require re-training of already consolidated parameters, and therefore cannot be forgotten as new classes are learned over time, which presents an important benefit for continual novelty detection (CND). In the example of FIG. 2, the memory updater circuitry 230 of the continual adaptive novelty detector 217 performs an update of the main model memory if the novel identifier circuitry 225 identifies novel samples (e.g., novelty determination 228). For example, the memory updater circuitry 230 stores the PCAs in the novelty data storage 232. In examples disclosed herein, samples flagged as novel can be used as training data to update and/or adapt the main model based on the active labels and/or pseudo labels. In examples disclosed herein, any classifier (e.g., main model) can be used in connection with continual novelty detection. In examples disclosed herein, continual novelty detection (e.g., as represented using continual adaptive novelty detector 217 of FIG. 2) is lightweight, having low memory usage and fast computation, given that this continual novelty detection retains one PCA per novel class, and only requires PCA computations (e.g., re-training of the main model is not needed). In examples disclosed herein, the final selection of novel samples, if detected using the novelty identifier circuitry 225, is used to update the continual adaptive novelty detection, such that the novel samples are no longer flagged as novel at any further point in time. Moreover, continual novelty detection as disclosed herein is designed to work in tandem with the deployed main model (e.g., a continual classifier), such that the novel selected samples (e.g., along with their pseudo or active labels) are also used as training data for the main model's update. Effectively, continual adaptive novelty detection, in combination with the main model classifier, enlarges the in-distribution data set over time and expands the in-knowledge memory and learning capacity (e.g., using the memory updater circuitry 230) as the post-deployment data distribution evolves and/or shifts. Subsequently, the main model can be adapted over time (e.g., model adaptation 235) without catastrophic forgetting (e.g., model-based loss of previously acquired knowledge when learning new tasks).

The novelty data storage 232 can be used to store any information associated with the neural network feature extractor circuitry 215, the iterative recruitment circuitry 220, the novelty identifier circuitry 225, and/or the memory updater circuitry 230. The novelty data storage 232 of the illustrated example of FIG. 2 can be implemented by any memory, storage device and/or storage disc for storing data such as flash memory, magnetic media, optical media, etc. Furthermore, the data stored in the novelty data storage 232 can be in any data format such as binary data, comma delimited data, tab delimited data, structured query language (SQL) structures, image data, etc.

The prediction generator circuitry 245 generates a prediction associated with the main model(s) (e.g., main model(s) M₀ 110, M₁ 125, M₂ 135, M₃ 145). In some examples, the prediction generator circuitry 245 outputs a prediction (e.g., output 250) when the novelty identifier circuitry 225 determines (e.g., using novelty determination 228) that the samples are not novel (e.g., not out-of-distribution), such that the prediction has a high level of accuracy. In some examples, the prediction generator circuitry 245 stores the prediction(s) and/or novelty sample results in the prediction data storage 247. Using methods and apparatus disclosed herein, the prediction generator circuitry 245 outputs a prediction that accounts for dataset drift, enhancing overall model performance compared to known novelty detection techniques. For example, the prediction generator circuitry 245 generates an output 250 once continual data drifts (e.g., novel classes) are detected and integrated into the main model (e.g., a classifier) to generate continual knowledge associated with identification of out-of-distribution data.

The prediction data storage 247 can be used to store any information associated with the neural network feature extractor circuitry 215, the iterative recruitment circuitry 220, the novelty identifier circuitry 225, and/or the prediction generator circuitry 245. The prediction data storage 247 of the illustrated example of FIG. 2 can be implemented by any memory, storage device and/or storage disc for storing data such as flash memory, magnetic media, optical media, etc. Furthermore, the data stored in the prediction data storage 247 can be in any data format such as binary data, comma delimited data, tab delimited data, structured query language (SQL) structures, image data, etc.

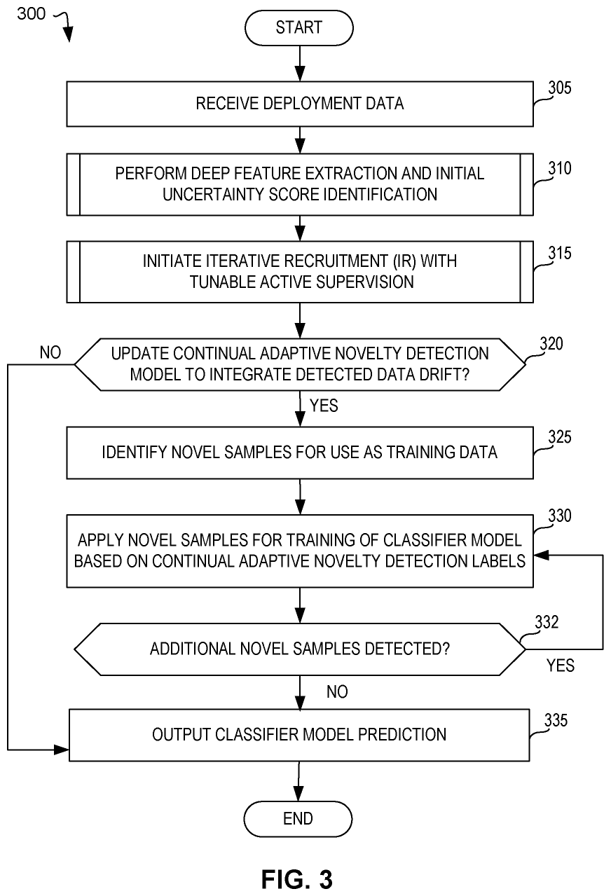

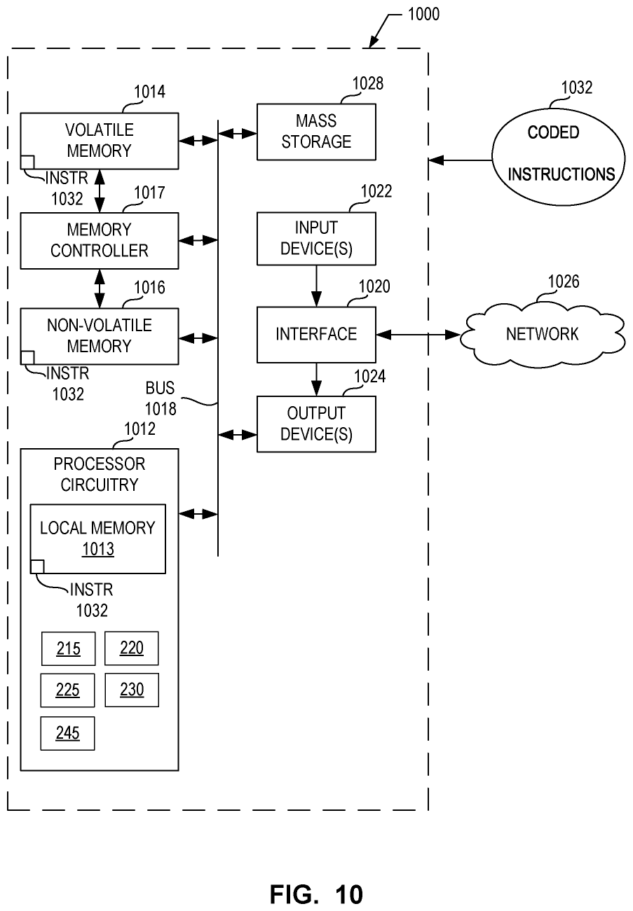

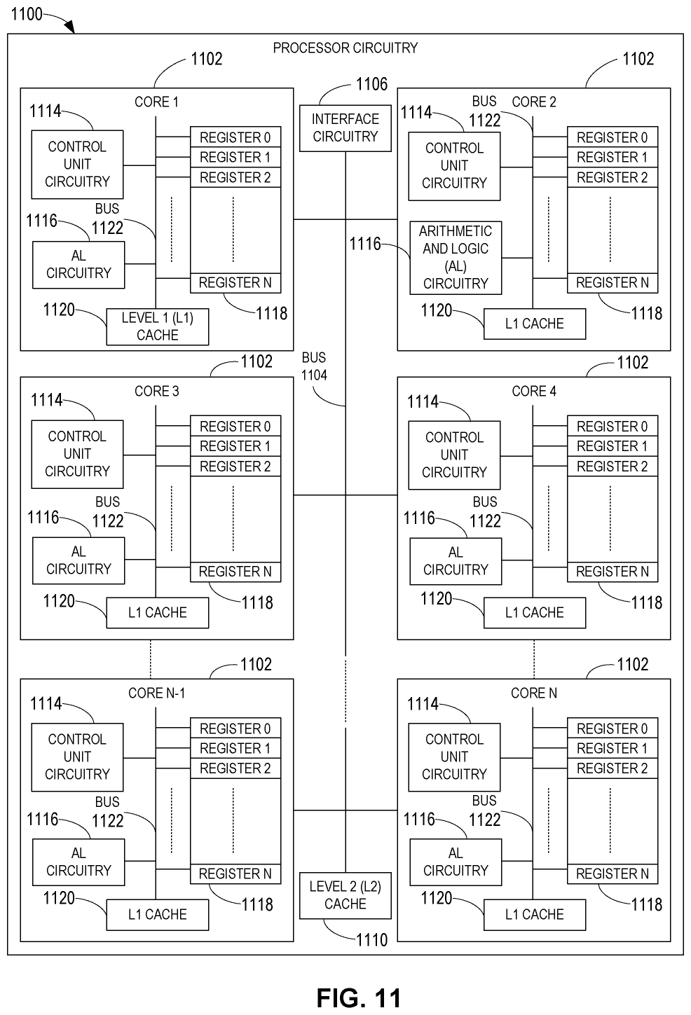

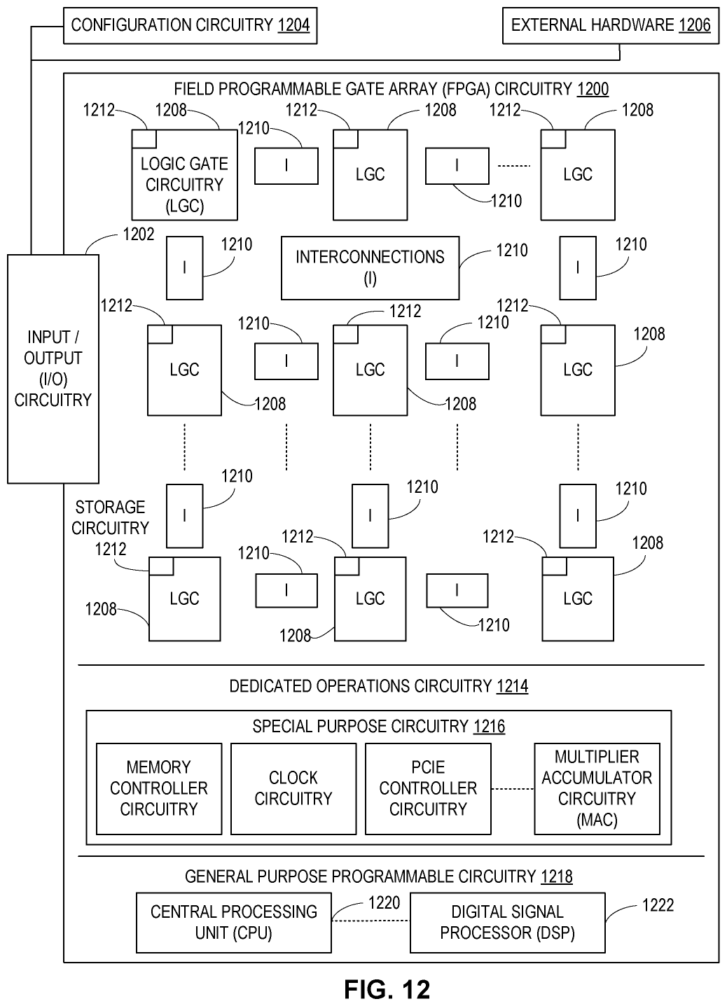

In some examples, the apparatus includes means for feature extraction. For example, the means for feature extraction may be implemented by neural network feature extractor circuitry 215. In some examples, the neural network feature extractor circuitry 215 may be instantiated by programmable circuitry such as the example programmable circuitry 1012 of FIG. 10. For instance, the neural network feature extractor circuitry 215 may be instantiated by the example microprocessor 1100 of FIG. 11 executing machine executable instructions such as those implemented by at least block 310 of FIG. 3. In some examples, the neural network feature extractor circuitry 215 may be instantiated by hardware logic circuitry, which may be implemented by an ASIC, XPU, or the FPGA circuitry 1200 of FIG. 12 structured to perform operations corresponding to the machine readable instructions. Additionally or alternatively, the neural network feature extractor circuitry 215 may be instantiated by any other combination of hardware, software, and/or firmware. For example, the neural network feature extractor circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for iterative recruitment. For example, the means for iterative recruitment may be implemented by iterative recruitment circuitry 220. In some examples, the iterative recruitment circuitry 220 may be instantiated by programmable circuitry such as the example programmable circuitry 1012 of FIG. 10. For instance, the iterative recruitment circuitry 220 may be instantiated by the example microprocessor 1100 of FIG. 11 executing machine executable instructions such as those implemented by at least block 315 of FIG. 3. In some examples, the iterative recruitment circuitry 220 may be instantiated by hardware logic circuitry, which may be implemented by an ASIC, XPU, or the FPGA circuitry 1200 of FIG. 12 structured to perform operations corresponding to the machine readable instructions. Additionally or alternatively, the iterative recruitment circuitry 220 may be instantiated by any other combination of hardware, software, and/or firmware. For example, the iterative recruitment circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for novelty identification. For example, the means for novelty identification may be implemented by novelty identifier circuitry 225. In some examples, the novelty identifier circuitry 225 may be instantiated by programmable circuitry such as the example programmable circuitry 1012 of FIG. 10. For instance, the novelty identifier circuitry 225 may be instantiated by the example microprocessor 1100 of FIG. 11 executing machine executable instructions such as those implemented by at least block 325 of FIG. 3. In some examples, the novelty identifier circuitry 225 may be instantiated by hardware logic circuitry, which may be implemented by an ASIC, XPU, or the FPGA circuitry 1200 of FIG. 12 structured to perform operations corresponding to the machine readable instructions. Additionally or alternatively, the novelty identifier circuitry 225 may be instantiated by any other combination of hardware, software, and/or firmware. For example, the novelty identifier circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for updating a memory. For example, the means for updating a memory may be implemented by memory updater circuitry 230. In some examples, the memory updater circuitry 230 may be instantiated by programmable circuitry such as the example programmable circuitry 1012 of FIG. 10. For instance, the memory updater circuitry 230 may be instantiated by the example microprocessor 1100 of FIG. 11 executing machine executable instructions such as those implemented by at least block 330 of FIG. 3. In some examples, the memory updater circuitry 230 may be instantiated by hardware logic circuitry, which may be implemented by an ASIC, XPU, or the FPGA circuitry 1200 of FIG. 12 structured to perform operations corresponding to the machine readable instructions. Additionally or alternatively, the memory updater circuitry 230 may be instantiated by any other combination of hardware, software, and/or firmware. For example, the memory updater circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating a prediction. For example, the means for generating a prediction may be implemented by prediction generator circuitry 245. In some examples, the prediction generator circuitry 245 may be instantiated by programmable circuitry such as the example programmable circuitry 1012 of FIG. 10. For instance, the prediction generator circuitry 245 may be instantiated by the example microprocessor 1100 of FIG. 11 executing machine executable instructions such as those implemented by at least block 335 of FIG. 3. In some examples, the prediction generator circuitry 245 may be instantiated by hardware logic circuitry, which may be implemented by an ASIC, XPU, or the FPGA circuitry 1200 of FIG. 12 structured to perform operations corresponding to the machine readable instructions. Additionally or alternatively, the prediction generator circuitry 245 may be instantiated by any other combination of hardware, software, and/or firmware. For example, the prediction generator circuitry 245 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the data drift detector circuitry 205 is illustrated in FIG. 2, one or more of the elements, processes and/or devices illustrated in FIG. 2 may be combined, divided, re-arranged, omitted, eliminated and/or implemented in any other way. Further, the example neural network feature extractor circuitry 215, the example iterative recruitment circuitry 220, the example novelty identifier circuitry 225, the example memory updater circuitry 230, the example prediction generator circuitry 245, and/or, more generally, the example data drift detector circuitry 205 of FIG. 2 may be implemented by hardware, software, firmware and/or any combination of hardware, software and/or firmware. Thus, for example, any of the example neural network feature extractor circuitry 215, the example iterative recruitment circuitry 220, the example novelty identifier circuitry 225, the example memory updater circuitry 230, the example prediction generator circuitry 245, and/or, more generally, the example data drift detector circuitry 205 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the data drift detector circuitry 205 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the data drift detector circuitry 205 of FIG. 2 and/or representative of example operations which may be performed by programmable circuitry to implement and/or instantiate the data drift detector circuitry 205 of FIG. 2, are shown in FIGS. 3-5. The machine readable instructions may be one or more executable programs or portion(s) of one or more executable programs for execution by programmable circuitry, such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 3-5, many other methods of implementing the example data drift detector circuitry 205 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

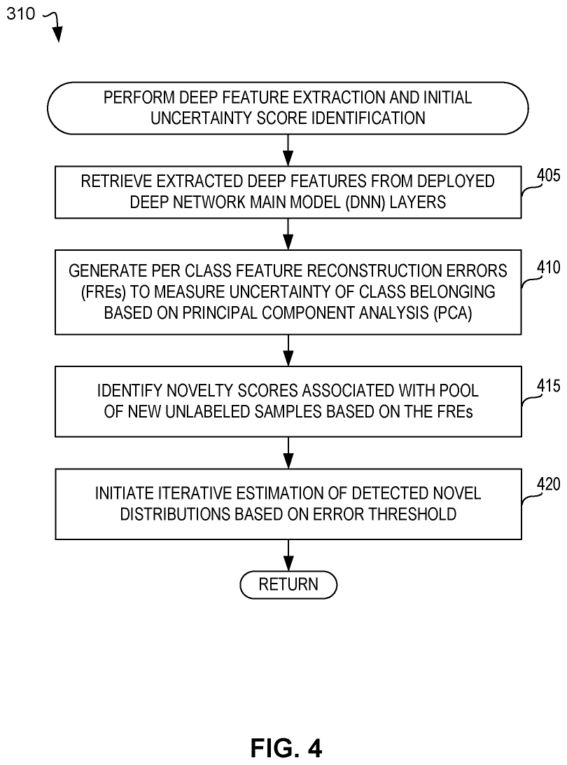

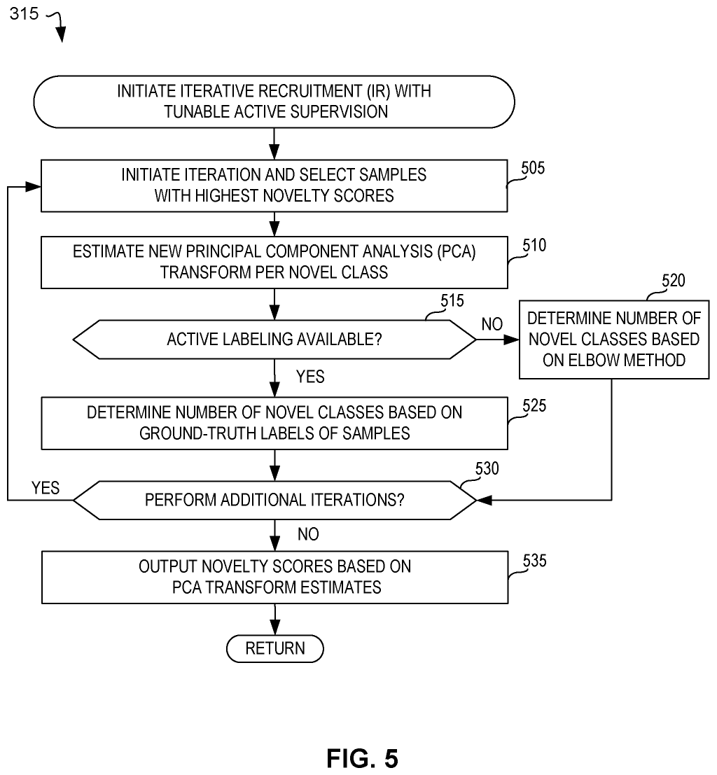

FIG. 3 is a flowchart representative of example machine readable instructions and/or example operations 300 that may be executed, instantiated, and/or performed by programmable circuitry to implement the example data drift detector circuitry 205 of FIG. 2. The machine-readable instructions and/or the operations 300 of FIG. 3 begin at block 305, at which the neural network feature extractor circuitry 215 receives deployment data (e.g., evolving data during deployment 210 of FIG. 2). The neural network feature extractor circuitry 215 and iterative recruitment circuitry 220 perform deep feature extraction and initial uncertainty score identification, respectively, at block 310. For example, as described in connection with FIG. 4, the neural network feature extractor circuitry 215 retrieves extracted deep features, while the iterative recruitment circuitry 220 generates per class feature reconstruction errors (FREs). Subsequently, the iterative recruitment circuitry initiates iterative recruitment with tunable active supervision, at block 315. For example, as described in connection with FIG. 5, the iterative recruitment circuitry 220 outputs novelty scores based on principal component analysis (PCA) transform estimates.

In the example of FIG. 3, the memory updater circuitry 230 determines whether to update the continual adaptive novelty detection model to integrate detected data drift, at block 320. For example, the novelty identifier circuitry 225 proceeds to identify novel samples for use as training data, at block 325. The novel sample identification is associated with k PCA transforms based on the use of active labeling or pseudo labeling. For example, samples identified using pseudo labeling and active labeling are used to re-estimate novelty scores for subsequent iterations. In the example of FIG. 3, the memory updater circuitry 230 applies novel samples (e.g., identified using the novelty identifier circuitry 225) for training of the main model (e.g., classifier model) based on continual adaptive novelty detection labels, at block 330. Once the novelty identifier circuitry 225 identifies all of the novel samples, at block 332, the prediction generator circuitry 245 outputs the classifier model prediction, at block 335.

FIG. 4 is a flowchart representative of example machine readable instructions and/or example operations 310 that may be executed, instantiated, and/or performed by programmable circuitry to implement the example data drift detector circuitry 205 of FIG. 2 to perform deep feature extraction and initial uncertainty score identification. The machine-readable instructions and/or the operations 310 of FIG. 3 begin at block 405, at which the neural network feature extractor circuitry 215 retrieves extracted deep features from deployed deep network main model (DNN) layers. For example, the neural network feature extractor circuitry 215 extracts intermediate features from a deployed DNN trained on original in-distribution (ID) pre-deployment data. The iterative recruitment circuitry 220 generates per class feature reconstruction errors (FREs) to measure uncertainty of class belonging (e.g., based on a principal component analysis (PCA)), at block 410. The iterative recruitment circuitry 220 identifies novelty scores associated with a pool of new unlabeled samples (e.g., determined using the FREs), at block 415. In some examples, the iterative recruitment circuitry 220 initiates iterative estimation of detected novel distributions based on an error threshold, at block 420. For example, the iterative recruitment circuitry 220 initiates iterative recruitment to iteratively estimate a detected novel distribution when a significant number of the samples are above an error threshold.

FIG. 5 is a flowchart representative of example machine readable instructions and/or example operations 315 that may be executed, instantiated, and/or performed by programmable circuitry to implement the example data drift detector circuitry 205 of FIG. 2 to initiate iterative recruitment with tunable active supervision. The machine-readable instructions and/or the operations 300 of FIG. 3 begin at block 505, at which the novelty identifier circuitry 225 initiates iteration and selects samples with the highest novelty scores. The novelty identifier circuitry 225 proceeds to estimate a new principal component analysis (PCA) transform per each identified novel class, at block 510. The novelty identifier circuitry 225 further identifies whether active labeling is available, at block 515, and proceeds to determine a number of novel classes based on the elbow method if active labeling is not available, at block 520. If the novelty identifier circuitry 225 determines that active labeling is available, at block 515, the novelty identifier circuitry 225 proceeds to determine a number of novel classes based on ground-truth labels of samples, at block 525. Once all iterations have been performed, at block 530, the novelty identifier circuitry 225 outputs novelty scores based on the PCA transform estimates, at block 535. For example, the novelty identifier circuitry 225 re-computes novelty scores (S_{t,i}) using updated PCA transform estimates, as described in more detail in connection with FIG. 2.

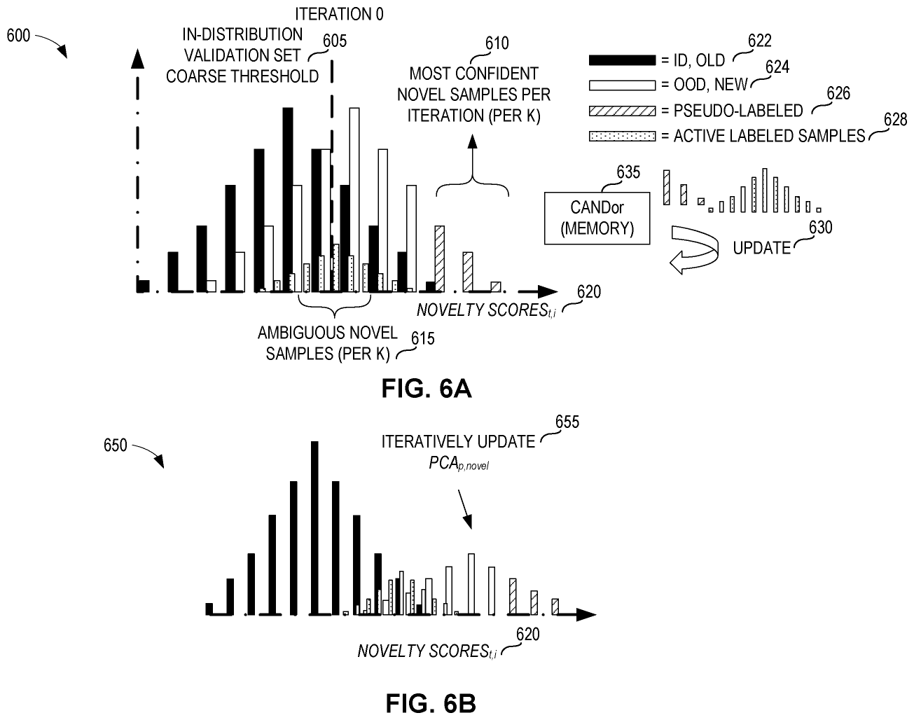

FIG. 6A illustrates example iterative recruitment 600 for incremental estimation of novelty, including an in-distribution validation threshold. In the example of FIG. 6A, novelty is estimated incrementally, such that at an initial iteration, both new and old distributions are mixed. However, at later iterations, the new and old distributions begin to separate as estimation of novelty is identified using the data drift detector circuitry 205 of FIG. 2 (e.g., via successive re-estimates of novelty scores using iterative recruitment). In the example of FIG. 6A, an in-distribution validation set coarse threshold 605 indicates mingling of new and old distributions at the onset of iteration (e.g., iteration 0), with most confident novel samples per iteration 610 (e.g., per k associated with the k-means clustering algorithm) shown towards later iterations. Likewise, ambiguous novel samples 615 (e.g., per k associated with the k-means clustering algorithm) are shown located at the initial iteration(s), with the novelty scores (S_{t,i}) 620 shown on the x-axis of the iterative recruitment 600. In the example of FIG. 6A, the iterative recruitment is classified based on in-distribution (ID/old data) samples 622, out-of-distribution (OOD/new data) samples 624, pseudo-labeled samples 626, and/or actively labeled samples 628. When the novelty identifier circuitry 225 re-computes novelty scores (S_{t,i}) using updated PCA transform estimates 630, the novel samples are stored in memory 635 and applied during training of the classifier model (e.g., the main model of FIG. 1). For example, FIG. 6B illustrates example iterative recruitment 650 with newer and older distributions separating in later tasks as identification of out-of-distribution data improves over time based on successive re-estimation of novelty scores (e.g., based on iterative updating 655 using PCA transform estimates).

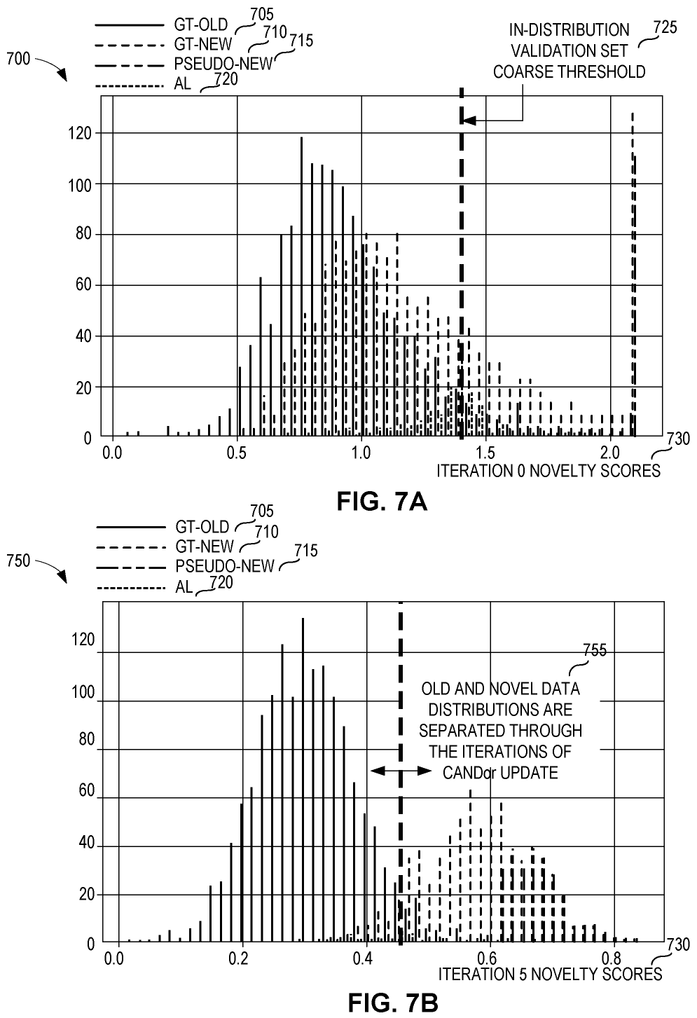

FIG. 7A illustrates an example first set of iterative recruitment results 700 showing an in-distribution validation set threshold. In the example of FIG. 7A, iterative recruitment is shown based on results obtained using CIFAR-100 dataset super-classes (e.g., two classes at a time). Over time, older and newer distributions become much more separable, as the data drift detector circuitry 205 of FIG. 2 selects topmost novel samples for pseudo-labeling and the most ambiguous samples for active labelling (e.g., assuming an active labeling budget of 5%). For example, FIG. 7B illustrates an example second set of iterative recruitment results 750 showing data distributions separated through iterations of successive re-estimation of novelty scores. In the example of FIGS. 7A-7B, samples are classified according to ground truth (GT)-based old samples 705, ground truth (GT)-based new samples 710, pseudo labeled new samples 715, and actively labeled new samples 720. In the example of FIG. 7A, an in-distribution validation set coarse threshold 725 identifies location of initial iteration(s) and subsequent changes in the novelty score(s) 730. In the example of FIG. 7B, old and novel data distributions 755 are shown separated due to iterations performed using data drift detector circuitry 205 of FIG. 2.

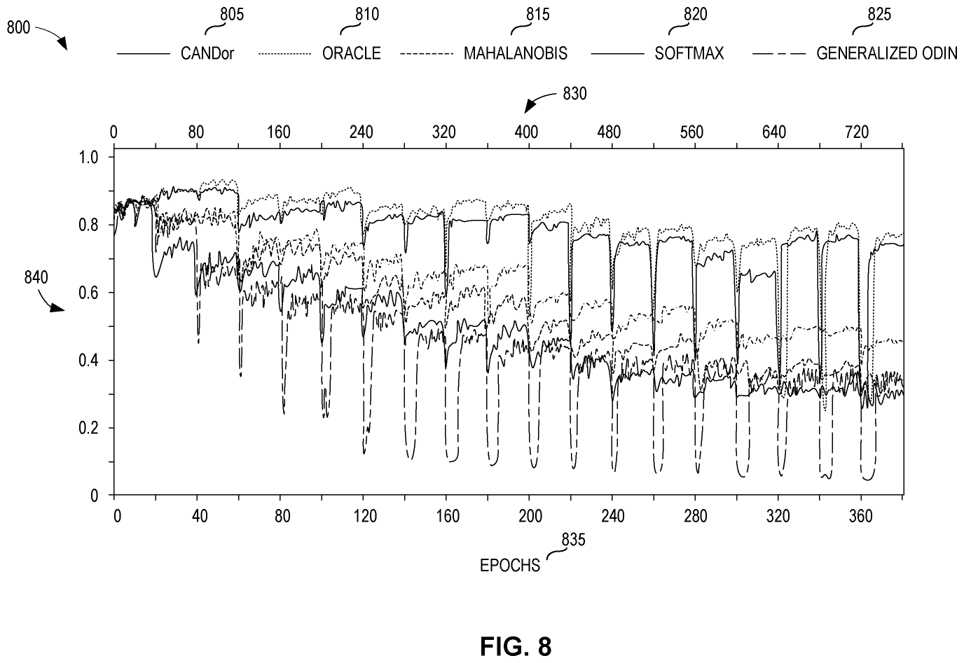

FIG. 8 illustrates an example of incremental classification accuracy 800 over a given number of tasks based on input of unlabeled data including in-distribution and out-of-distribution samples. In the example of FIG. 8, incremental classification results based on a CIFAR-100 dataset are shown for a full workstream associated with the methods and apparatus disclosed herein 805 (e.g., using the data drift detector circuitry 205 of FIG. 2), including classification results associated with methods (e.g., static OOD methods) such as Oracle 810, Mahalanobis 815, Softmax 820, and Generalized Odin 825. In the example of FIG. 8, a perceptron trained with deep experience replay is used as a plug-in incremental classifier. Results associated with the methods and apparatus disclosed herein 805 are obtained using unsupervised continual adaptive novelty detection (e.g., using no active budget), when one novel class is introduced at a time (e.g., mixed with a cumulative number of previously unseen samples of past classes). In the example of FIG. 8, each vertical dashed line 830 indicates when unlabeled data is fed to the workstream, which includes a mixture of in-distribution (ID) and out-of-distribution (OOD) samples over a given epoch 835, whereas the y-axis 840 shows average incremental classification accuracy over tasks.

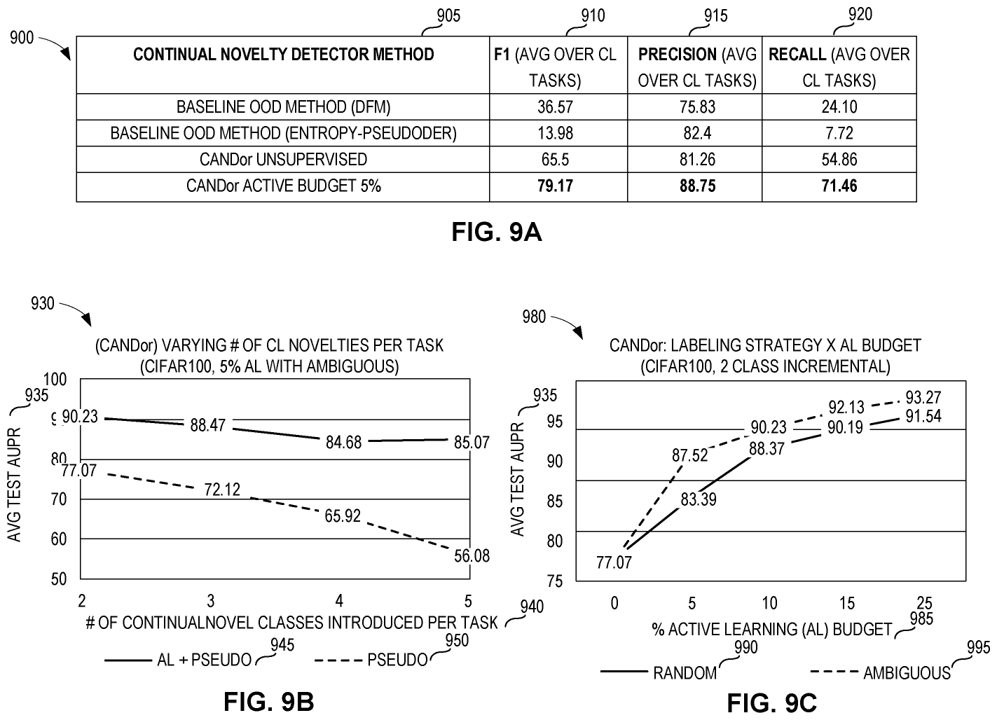

FIG. 9A illustrates example results 900 including average precision and recall associated with continual novelty detection performance with multiple shifts in deployment distribution. In the example of FIG. 9A, methods and apparatus disclosed herein are shown to achieve state-of-the-art results in continuous novelty detection of novel classes (e.g., drifts) as showcased, when either fully unsupervised or semi-supervised. For example, methods and apparatus disclosed herein apply a small tunable active learning budget to enhance continual detection performance in more challenging operational scenarios. Importantly, methods and apparatus disclosed herein introduce an iterative novelty-recruitment algorithm that can operate on frozen post-deployment deep neural network features, bypassing the need for expensive re-trainings of DNNs while achieving low latency adaptation suitable to edge-related applications. In the example of FIG. 9A, continual novelty detection methods 905 include a first baseline out-of-distribution (OOD) method (e.g., deep feature modeling, DFM), a second baseline OOD method (e.g., Entropy-PseudoDER), and the continual adaptive novelty detection method disclosed herein (e.g., unsupervised or with a 5% active budget).

In the example of FIG. 9A, results are shown based on an F1 score (e.g., a measure of the harmonic mean of precision and recall) 910, precision 915, and recall 920 (e.g., average values over continual learning tasks). For example, results using an incremental CIFAR-100 dataset show a 79% or a 116% increase in F1 scores 910 (e.g., over the DFM baseline) when using 0% or only 5% active supervision, respectively. Average precision 915 and recall 920 are identified after all continual tasks are completed (e.g., 10 tasks with 2 novel classes introduced and mixed with unseen old class samples). In examples disclosed herein, the deployment distribution shifts several times with the introduction of novel classes, and models based on the methods and apparatus disclosed herein adapt to all incoming novelties. Competing methods such as DFM or PseudoDER do not successfully detect and update to continual novelties, such that an accumulation of errors significantly degrades their detection performance (e.g., based on F1 scores 910) over time.

FIG. 9B illustrates an example graphical representation 930 of an increase in novelty detection capacity over time when using active learning in combination with data including pseudo-labeling as compared to the use of data with pseudo-labeling alone. In the example of FIG. 9B, a small active learning budget (e.g., 5% budget) greatly increases novelty detection capacity of the continual adaptive novelty detector (CANDor) 217 of FIG. 2 when compared to unsupervised pseudo-labeling only, especially when novelties contain several unknown classes each time. For example, FIG. 9B includes an average test AUPR 935 (e.g., area under precision recall curve), with a number of continual novel classes introduced per task 940, where results are indicated based on active learning in combination with pseudo-labeling 945 and pseudo-labeling alone 950. Alternatively, FIG. 9C illustrates an example graphical representation 980 of increased efficiency when using active learning as compared to using simple semi-supervised learning. For example, FIG. 9C includes an average test AUPR (e.g., area under precision recall curve) 935, with a percentage (%) of an active learning (AL) budget 985, where results are indicated based on use of simple semi-supervised learning (e.g., random) 990 compared to application of an active learning heuristic based on feature reconstruction errors (e.g., ambiguous) 995. In the example of FIG. 9C, use of the active learning heuristic is considerably more efficient than simple semi-supervised learning (e.g., random 990) through a range of labeling budget(s) 985. As such, application of an active heuristic (e.g., based on novelty uncertainty) significantly minimizes the supervision budget.

In examples disclosed herein, an uncertainty analysis can be executed on a reference dataset with a continual learning scheduling regime that includes the reference dataset (e.g., pre-selected dataset) divided into subsections, each subsection containing an orthogonal portion of classes. In each subsection, 80% of the data can be used for out-of-distribution (OOD) data points and the remaining 20% of the data can be used at later times as unseen in-distribution (ID) data points (e.g., known classes but unseen samples). For example, each time novel classes (e.g., OOD samples) are introduced to the system, the novel classes are mixed with an equal or greater number of hold-out ID data samples. Such a mixture of unseen but known class ID samples with novel class OOD samples can be identified as a separate task. In some examples, a range of possible labelling budgets is pre-set (e.g., from 0% to 15% of each unlabeled task). This type of profiling protocol includes a succession of tasks containing ID and OOD mixtures, allowing for a range of supervision budgets, as described in connection with FIG. 9C.

In examples disclosed herein, well-separated uncertainty scores are continuously generated for the ID and OOD samples, respectively, for all tasks over time, generating a unique reference uncertainty profile to compare against. In examples disclosed herein, at each task (e.g., new ID/OOD split) only the principal component analysis (PCA) parameters are identified and PCA reconstruction scores are generated iteratively. However, using methods and apparatus disclosed herein, no additional training is needed, since PCA parameters are determined on top of a frozen pre-trained deep embedding (e.g., an ImageNet-based pretrained deep neural network). As such, compared to other static OOD-based methods, low latency and faster responses are achieved using the methods and apparatus disclosed herein.

FIG. 10 is a block diagram of an example programmable circuitry platform 1000 structured to execute and/or instantiate the example machine-readable instructions and/or the example operations of FIGS. 3-5 to implement the example data drift detector circuitry 205 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs microprocessors, CPUs, GPUs, DSPs, and/or microcontrollers from any desired family or manufacturer. The programmable circuitry 1012 may be implemented by one or more semiconductor based (e.g., silicon based) devices. In this example, the processor circuitry 1012 implements the neural network feature extractor circuitry 215, the iterative recruitment circuitry 220, the novelty identifier circuitry 225, the memory updater circuitry 230, and the prediction generator circuitry 245.

The programmable circuitry 1012 of the illustrated example includes a local memory 1013 (e.g., a cache, registers, etc.). The programmable circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1000 of the illustrated example also includes one or more mass storage devices 1028 to store software and/or data. Examples of such mass storage devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1032, which may be implemented by the machine readable instructions of FIGS. 3-5, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowcharts of FIGS. 3-5 to effectively instantiate the circuitry of FIG. 2 logic circuits to perform the operations corresponding to those machine readable instructions. In some such examples, the circuitry of FIG. 2 is instantiated by the hardware circuits of the microprocessor 1100 in combination with the instructions. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 3-5.

The cores 1102 may communicate by a first example bus 1104. In some examples, the first bus 1104 may implement a communication bus to effectuate communication associated with one(s) of the cores 1102. For example, the first bus 1104 may implement at least one of an Inter-Integrated Circuit (I2C) bus, a Serial Peripheral Interface (SPI) bus, a PCI bus, or a PCIe bus. Additionally or alternatively, the first bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating point operations. In some examples, the AL circuitry 1016 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 3-5 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 3-5. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 3-5. As such, the FPGA circuitry 1200 may be configured and/or structured to effectively instantiate some or all of the operations/functions corresponding to the machine readable instructions of the flowcharts of FIGS. 3-5 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 3-5 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 3-5 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1202 of FIG. 12 may execute a first portion of the machine readable instructions represented by the flowchart(s) of FIGS. 3-5 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 3-5, and/or an ASIC may be configured and/or structured to perform third operation(s)/function(s) corresponding to a third portion of the machine readable instructions represented by the flowcharts of FIGS. 3-5.

It should be understood that some or all of the circuitry of FIG. 2 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 2 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10 which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

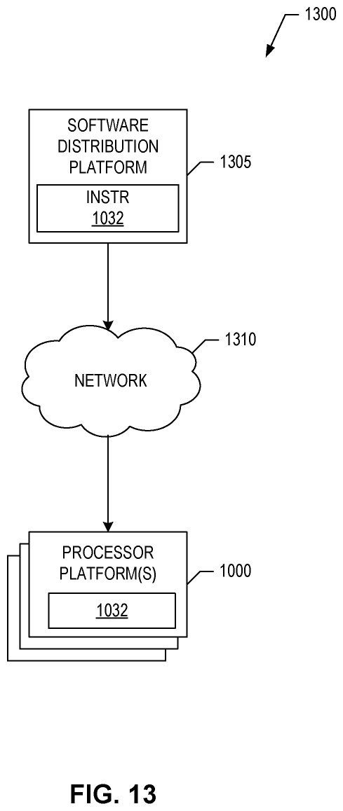

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 3-5, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIGS. 3-5, may be downloaded to the example programmable circuitry platform 1000, which is to execute the machine readable instructions 1032 to implement the data drift detector circuitry 205 of FIG. 2. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein provide data-efficient continual adaptation to post-deployment novelties for autonomous systems. In examples disclosed herein, continuous novelty detection of novel classes (e.g., data drift detection) is performed under fully unsupervised or semi-supervised conditions, including using a small tunable active learning budget to enhance continual detection performance in more challenging operational scenarios. In examples disclosed herein, an iterative novelty-recruitment algorithm can operate on frozen post-deployment deep neural network features, bypassing computationally expensive re-trainings of deep neural networks (DNNs) and achieving low latency adaptation suitable to edge applications. In examples disclosed herein, novel samples are continuously identified in real-time and subsequently incorporated into the training data for future neural network model updates. Thus, examples disclosed herein result in improvements to the operation of a machine.

Example methods, apparatus, systems, and articles of manufacture for data-efficient continual adaptation to post-deployment novelties for autonomous systems are disclosed herein. Further examples and combinations thereof include the following:

Example 1 includes an apparatus, comprising interface circuitry, machine-readable instructions, and at least one processor circuit to be programmed by the machine-readable instructions to extract neural network model features from deployment data, identify out-of-distribution data based on the neural network model features, identify samples with the out-of-distribution data to generate one or more scores associated with post-deployment data drift, and classify post-deployment data based on the one or more scores.

Example 2 includes the apparatus of example 1, wherein one or more of the at least one processor circuit is to identify out-of-distribution data based on a per class feature reconstruction error to measure uncertainty of class belonging using principal component analysis.

Example 3 includes the apparatus of one or more of examples 1-2, wherein one or more of the at least one processor circuit is to identify the one or more scores associated with a pool of unlabeled samples based on the feature reconstruction error.

Example 4 includes the apparatus of one or more of examples 1-3, wherein one or more of the at least one processor circuit is to iteratively identify the samples with the out-of-distribution data based on an error threshold.

Example 5 includes the apparatus of one or more of examples 1-4, wherein one or more of the at least one processor circuit is to iteratively identify the samples with the out-of-distribution data using a principal component analysis transform.

Example 6 includes the apparatus of one or more of examples 1-5, wherein one or more of the at least one processor circuit is to decrease a size of a training dataset based on the out-of-distribution data.

Example 7 includes the apparatus of one or more of examples 1-6, wherein one or more of the at least one processor circuit is to determine a number of classes associated with the scores using ground-truth sample labels in connection with active labelling.

Example 8 includes at least one non-transitory machine-readable medium comprising machine-readable instructions to cause at least one processor circuit to at least extract neural network model features from deployment data, identify out-of-distribution data based on the neural network model features, identify samples with the out-of-distribution data to generate one or more scores associated with post-deployment data drift, and classify post-deployment data based on the one or more scores.

Example 9 includes the at least one non-transitory machine-readable medium of example 8, wherein the machine-readable instructions are to cause one or more of the at least one processor circuit to identify out-of-distribution data based on a per class feature reconstruction error to measure uncertainty of class belonging using principal component analysis.

Example 10 includes the at least one non-transitory machine-readable medium of one or more of examples 8-9, wherein the machine-readable instructions are to cause one or more of the at least one processor circuit to identify the one or more scores associated with a pool of unlabeled samples based on the feature reconstruction error.

Example 11 includes the at least one non-transitory machine-readable medium of one or more of examples 8-10, wherein the machine-readable instructions are to cause one or more of the at least one processor circuit to iteratively identify samples with the out-of-distribution data based on an error threshold.

Example 12 includes the at least one non-transitory machine-readable medium of one or more of examples 8-11, wherein the machine-readable instructions are to cause one or more of the at least one processor circuit to decrease a size of a training dataset based on the out-of-distribution data.

Example 13 includes the at least one non-transitory machine-readable medium of one or more of examples 8-12, wherein the machine-readable instructions are to cause one or more of the at least one processor circuit to iteratively identify the samples with the out-of-distribution data using a principal component analysis transform.

Example 14 includes the at least one non-transitory machine-readable medium of one or more of examples 8-13, wherein the machine-readable instructions are to cause one or more of the at least one processor circuit to determine a number of classes associated with the scores using ground-truth sample labels in connection with active labelling.

Example 15 includes a method comprising extracting neural network model features from deployment data, identifying, by at least one processor circuit programmed by at least one instruction, out-of-distribution data based on the neural network model features, identifying, by one or more of the at least one processor circuit, samples with the out-of-distribution data to generate one or more scores associated with post-deployment data drift, and classifying post-deployment data based on the one or more scores.

Example 16 includes the method of example 15, further identifying out-of-distribution data based on a per class feature reconstruction error to measure uncertainty of class belonging using principal component analysis.

Example 17 includes the method of one or more of examples 15-16, further identifying the one or more scores associated with a pool of unlabeled samples based on the feature reconstruction error.

Example 18 includes the method of one or more of examples 15-17, further iteratively identifying samples with the out-of-distribution data based on an error threshold.

Example 19 includes the method of one or more of examples 15-18, further iteratively identifying the samples with the out-of-distribution data using a principal component analysis transform.

Example 20 includes the method of one or more of examples 15-19, further decreasing a size of a training dataset based on the out-of-distribution data.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
extract neural network model features from deployment data;
identify out-of-distribution data based on the neural network model features;
identify samples with the out-of-distribution data to generate one or more scores associated with post-deployment data drift; and
classify post-deployment data based on the one or more scores.

2. The apparatus of claim 1, wherein one or more of the at least one processor circuit is to identify out-of-distribution data based on a per class feature reconstruction error to measure uncertainty of class belonging using principal component analysis.

3. The apparatus of claim 2, wherein one or more of the at least one processor circuit is to identify the one or more scores associated with a pool of unlabeled samples based on the feature reconstruction error.

4. The apparatus of claim 1, wherein one or more of the at least one processor circuit is to iteratively identify the samples with the out-of-distribution data based on an error threshold.

5. The apparatus of claim 1, wherein one or more of the at least one processor circuit is to iteratively identify the samples with the out-of-distribution data using a principal component analysis transform.

6. The apparatus of claim 1, wherein one or more of the at least one processor circuit is to decrease a size of a training dataset based on the out-of-distribution data.

7. The apparatus of claim 1, wherein one or more of the at least one processor circuit is to determine a number of classes associated with the scores using ground-truth sample labels in connection with active labelling.

8. At least one non-transitory machine-readable medium comprising machine-readable instructions to cause at least one processor circuit to at least:
extract neural network model features from deployment data;
identify out-of-distribution data based on the neural network model features;
identify samples with the out-of-distribution data to generate one or more scores associated with post-deployment data drift; and
classify post-deployment data based on the one or more scores.

9. The at least one non-transitory machine-readable medium of claim 8, wherein the machine-readable instructions are to cause one or more of the at least one processor circuit to identify out-of-distribution data based on a per class feature reconstruction error to measure uncertainty of class belonging using principal component analysis.

10. The at least one non-transitory machine-readable medium of claim 9, wherein the machine-readable instructions are to cause one or more of the at least one processor circuit to identify the one or more scores associated with a pool of unlabeled samples based on the feature reconstruction error.

11. The at least one non-transitory machine-readable medium of claim 8, wherein the machine-readable instructions are to cause one or more of the at least one processor circuit to iteratively identify samples with the out-of-distribution data based on an error threshold.

12. The at least one non-transitory machine-readable medium of claim 8, wherein the machine-readable instructions are to cause one or more of the at least one processor circuit to decrease a size of a training dataset based on the out-of-distribution data.

13. The at least one non-transitory machine-readable medium of claim 8, wherein the machine-readable instructions are to cause one or more of the at least one processor circuit to iteratively identify the samples with the out-of-distribution data using a principal component analysis transform.

14. The at least one non-transitory machine-readable medium of claim 8, wherein the machine-readable instructions are to cause one or more of the at least one processor circuit to determine a number of classes associated with the scores using ground-truth sample labels in connection with active labelling.

15. A method comprising:
extracting neural network model features from deployment data;
identifying, by at least one processor circuit programmed by at least one instruction, out-of-distribution data based on the neural network model features;
identifying, by one or more of the at least one processor circuit, samples with the out-of-distribution data to generate one or more scores associated with post-deployment data drift; and
classifying post-deployment data based on the one or more scores.

16. The method of claim 15, including identifying out-of-distribution data based on a per class feature reconstruction error to measure uncertainty of class belonging using principal component analysis.

17. The method of claim 16, including identifying the one or more scores associated with a pool of unlabeled samples based on the feature reconstruction error.

18. The method of claim 15, including iteratively identifying samples with the out-of-distribution data based on an error threshold.

19. The method of claim 15, including iteratively identifying the samples with the out-of-distribution data using a principal component analysis transform.

20. The method of claim 15, including decreasing a size of a training dataset based on the out-of-distribution data.
